(19) United States
(12) Patent Application Publication
(10) Pub. No.: US 2013/0167525 A1
(43) Pub. Date: Jul. 4, 2013

(54) Apparatus and method to extract more energy efficiently in a hydrogen fuel cell vehicle

(71) Applicant: Mhamad Salih, Mississauga (CA)

(72) Inventor: Mhamad Salih, Mississauga (CA)

(21) Appl. No.: 13/339,357

(22) Filed: Dec. 28, 2011

(51) Int. Cl. F02G 1/043; F17C 3/00

(52) U.S. Cl. 60/517; 62/51.1

(57) ABSTRACT

An apparatus and a method to extract more energy from liquid hydrogen than the currently used method in hydrogen fuel cells, to harness the energy efficiently, to cool down hot parts of a vehicle while using that heat to power the vehicle and to extract energy from the ambient air to power the vehicle. The apparatus uses simple thermodynamic rules to take advantage of the waste heat generated in the vehicle. The apparatus (Systematic Application of Liquid Ingredients to Harness energy, SALIH for short) will theoretically double the efficiency of a hydrogen fuel cell vehicle, allowing it to travel the same distance of the current average family sedan.

### BACKGROUND OF THE INVENTION

As the world is moving into an economic and an energy crisis and global warming, research and development into solving these issues have been greatly transformed. Most of the roots associated with these problems can be traced back to the use of oil to power our world. Currently, 40% of the petrol consumption today is used by automobiles. As the oil in the oil reserves is nearing its complete consumption, the importance of finding an energy alternative is critical for the survival of the human race in the coming decades. The first step to solving this issue would be to replace the petrol vehicle with a clean, environmentally-friendly and economic alternative.

Till today, many alternatives have been proposed to replace the petrol automobile. Although most of the alternatives work, they still do not compete with petrol when it comes to distance travelled on a single full tank of fuel. Currently used hydrogen fuel cell vehicles achieve the highest driving distance when compared to the other alternatives. Nonetheless, Hydrogen fuel cells undertake a driving range of roughly 400 km (250 miles) between refueling. An average petrol car travels about 760 km (470 miles) on a single full tank, about twice as that of a hydrogen fuel cell. This makes the hydrogen fuel cells the best competing energy alternative relative to the other alternatives as a replacement of the petrol vehicle. It is clear that all research and investment into an alternative energy vehicle to replace the petrol vehicle should be a hydrogen fuel cell.

However, the main flaw with hydrogen fuel cells is simply the enormous amounts of heat generated when hydrogen is reacted with oxygen to produce water. If it were possible to harness the heat generated from this reaction to power the vehicle, the efficiency would be greatly amplified as well as the mileage. Roughly half of the energy produced in a hydrogen fuel cell is heat, so if it were possible to make use of that heat, then the driving distance on a single full tank of hydrogen fuel should be doubled. At the same time, if it is possible to harness the heat to power the vehicle, then it should also be possible to harness the heat generated from the battery, brakes, electric motor and other parts of the vehicle. This will maximize the efficiency of the vehicle not just in terms of using the waste heat to power the vehicle, but also because devices that produce waste heat usually work more efficiently if they are cooled.

Originally, the idea began at simply attaching free-piston Stirling engines to the exhaust of the vehicle. The most efficient Stirling engines to this day achieve an optimal efficiency around 36%. If Stirling engines were attached to the exhaust pipe, then 36% percent of the heat will be converted to electrical energy, and the remaining 64% will exit the vehicle as “waste heat”. This would only add an additional 18% to the hydrogen fuel cell vehicle, increasing its efficiency from 50% to 68%. The increase in efficiency is considered to be quite a development but it still cannot compete with the petrol automobile. A 68% efficient hydrogen fuel cell vehicle would theoretically accomplish a distance of about 480 km (300 miles). The efficiency required for a hydrogen fuel cell vehicle to successfully overcome the petrol vehicle would be approximately 90% to 100%. In a more simple explanation, almost all of the waste heat generated from the fuel cell should be converted to electrical energy in order for the hydrogen fuel cell vehicle to make the petrol vehicle become history in a science museum.

This necessity has motivated the use of liquid hydrogen at super cool temperatures as the means to absorb the “waste heat” produced by many parts of the vehicle. The fuel (liquid hydrogen) will have two purposes; to provide energy from a chemical reaction (hydrogen fuel cell), and to provide energy in physical form (expansion of the extreme pressure achieved inside the tank through an air motor). Theoretically, half the distance travelled by the vehicle will be powered by the physical reaction, and the other half powered by the chemical reaction.

### SUMMARY OF THE INVENTION

The invention makes it possible for the vehicle to use the same amount of fuel to travel further than the current method of generating electrical energy from hydrogen fuel cells. This is done by creating a temperature differential between the hydrogen tank and its environment. The environment in this case is all the parts of the vehicle that produce waste heat as well as the ambient air surrounding the vehicle. This constitutes a physical equilibrium reaction where the waste heat produced will travel to the colder medium of the vehicle, passing through multiple free-piston Stirling engines, generating electrical energy and the remaining heat is stored in a tank as potential energy.

It is possible that this invention will allow the vehicle to use more energy than it was originally fueled with (obtaining an efficiency greater than 100%), mainly due to the heat from the surrounding air being harnessed to power the vehicle. Otherwise, the overall efficiency of the vehicle will be greatly improved, maximizing the mileage and economy of today's fuel cell automotive transportation.

### DESCRIPTION OF THE DRAWINGS

FIG. 1 represents the apparatus itself with a quarter of the insulating tank removed to reveal the inner contents of the apparatus. The following information will further explain each numbered part of the diagram.
1. Cold end of a Stirling engine: a Stirling engine is a cryogenic engine that works on a differential of temperature. As long as the exposed side of the Stirling engine is at a higher temperature than the cold side, heat from the warmer medium will flow through the Stirling engine and to the colder medium. Approximately ⅓ of the heat flowing into the Stirling engine will be converted to electrical energy, while the remaining ⅔ of the heat will travel to the inner tank, causing its contents to increase in temperature and pressure.
2. Air motor/turbine: as the contents of the inner tank rise in temperature and reach an extraordinary pressure, the contents are then released via the air motor which spins a turbine and a generator to produce electrical energy. The contents (hydrogen gas) will then reach the hydrogen fuel cells for further production of electrical energy.
3. Hot end of a Stirling engine: the hot end of the Stirling engine is connected to the exhaust pipe that carries the products (h2o). The hot sides of the Stirling engines are also attached to other mechanical parts of the vehicle that require cooling via an insulated iron cable and/or any other method to allow heat to travel more efficiently.
4. Liquid hydrogen tank (inner tank): the liquid hydrogen tank is a non-insulated tank. The contents remain inside the tank while the tank's exterior surface heats up as the helium gas receives the heat from the cold side of the Stirling engine. The heat will then transfer to the hydrogen increasing its temperature and pressure within the inner tank.
5. Insulated tank (outer tank): a hermetically sealed tank that prevents heat from the outside environment to enter and heat up the inner tank. This tank contains ports where Stirling engines are fitted and these Stirling engines are the only devices that allow heat to pass through.
6. Helium compressor and storage: this device contains both a compressor and a small tank that is able to store all of the helium which fills the medium between the inner and outer tanks. The compressor regulates the helium pressure to adjust the rate of heat flow. When the vehicle is turned off, all of the helium is sucked and compressed into the mini helium tank. This creates a vacuum between the inner and outer tank, which prevents the heat to flow to the inner tank. This will make the contents of the inner tank stay at its current temperature and pressure.

FIG. 2 displays the general interaction of the apparatus with other parts of a fuel cell vehicle. The hydrogen is released via the high pressure in the liquid hydrogen tank, turning the air motor to generate electrical energy, then making its way to the hydrogen fuel cell stacks, generating further electrical energy and heat. The electrical energy generated is used to power the vehicle, which in turn, causes parts of the vehicle to heat up; such as the motor, brakes and battery etc. the heat generated flows back to the S.A.L.I.H. apparatus, entering the Stirling engines. Some of the heat will be converted to electrical energy instantly, but the remaining heat will exit the other side and raise the temperature of the hydrogen in the hydrogen fuel tank. This results in a direct increase in both pressure and potential energy. The process then repeats itself until all the fuel is consumed.

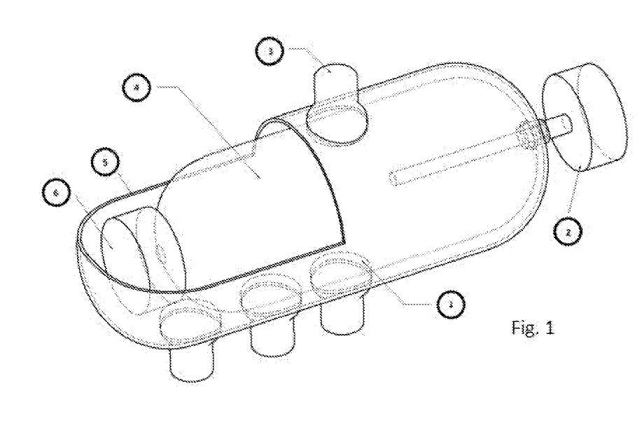

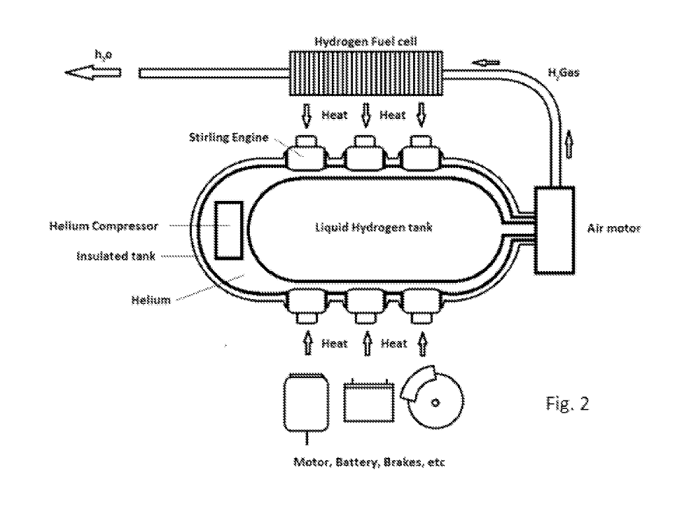

### DETAILED DESCRIPTION OF THE INVENTION

The apparatus focuses on two tanks, one that contains the liquid hydrogen at supercool temperatures, and the other contains the liquid hydrogen tank. They are the inner and outer tanks. The outer tank is an insulated tank, in other words, heat from the outside environment cannot get through the outer tank and heat up the inner tank and its contents (liquid hydrogen).

The outer tank contains ports or holes where the free-piston Stirling engines are placed, sealing the holes tightly. The hot side of the Stirling engine is exposed outside of the tank, while the cold side of the Stirling engine is exposed to the interior. Although the cold side of the Stirling engine is inside of the outer tank, it still does not make contact with the inner tank. This allows heat to only travel by convection and radiation rather than conduction.

The outer tank holds another device which contains a compressor and a small helium storage tank. The purpose of this device is to regulate the pressure of the helium available inside and between the inner and outer tanks. The pressure of helium is directly proportional to the rate at which heat flows from the outside environment, to the hot side of the Stirling engine, through the Stirling engine and to the cold end, to the helium particles, and into the inner tank and its contents. The helium compressor is controlled by an onboard computer that determines the most efficient rate of heat flow based on the needs to power the vehicle.

As heat flows from the hot side of the Stirling engine to the cold side, roughly a third of the heat is converted to electrical energy, the remaining two-thirds of the energy flows through the cold side to the helium particles and then to the inner tank. This results in an increase in both temperature and pressure of the hydrogen. This becomes potential energy to be used at the discretion of the onboard computer based on the needs to power the vehicle.

The electrical energy generated from the Stirling engine is fed either directly to the electric motor to power the vehicle and/or to charge an electric battery.

Once the temperature of the hydrogen approaches the ambient temperature, the pressure will become extremely high (roughly 800× the initial pressure). The hydrogen gas is then released from the inner tank, to an air motor and generator which generates electrical energy. As the hydrogen gas particles exit the air motor, they travel to the hydrogen fuel cells, generating further electrical energy to be supplied to the electric motor and/or battery.

Once the hydrogen particles enter the fuel cells, they react to form h2o (water) and an immense amount of heat and electricity. Roughly half of the energy produced from the reaction is heat.

The hot sides of the Stirling engines are connected to both the hydrogen fuel cells and to the exhaust pipe that carries the h2o molecules. This takes advantage of the “waste heat” where two important events happen. The first event; the fuel cells and the water molecules are cooled. This allows the vehicle to work more efficiently. The second important event; the heat produced from the fuel cells flows back through the process again, generating further electrical energy and stored as potential energy into the remaining hydrogen in the inner tank. This results in an increase of pressure and temperature. This method of electrical generation takes full advantage of the hydrogen fuel cell reaction, and using almost all of the available energy to power the vehicle.

Although some of the hot sides of the Stirling engines are attached to the hydrogen fuel cell and exhaust pipe, not all of the Stirling engines are. Some of the Stirling engines are attached to only the electric motor, battery, brakes and other parts of a vehicle that require cooling. This arrangement prevents the possibility of heat from the hydrogen fuel cell reaction to travel to the motor, battery and other parts which require cooling. This might happen because the heat from the motor, brakes and batteries is less than that of the hydrogen fuel cell and exhaust pipe.

The Stirling engines also absorb heat from the ambient air surrounding the vehicle, and using that heat to power the vehicle.

1. An apparatus for, but not limited to, an electric vehicle that harnesses heat from the surrounding environment (outside air, heat produced from the hydrogen fuel cell reaction, electric motor, lithium ion battery, brakes and other hot parts of a vehicle) as a means to power the vehicle using the electricity generated by both the Stirling engines and the air motor.

2. A non-insulated tank containing liquid hydrogen, surrounded by an insulated tank that contains ports where the cold end of a Stirling engine is placed and facing the liquid hydrogen tank, while the hot end of the Stirling engine is exposed externally.

3. A system according to claim 2, which acts as, but not limited to, an energy storing device and a cooling device for mechanical parts and any other devices inside of a vehicle which require cooling.

4. The use of helium gas as the working substance between the inner and outer tanks to allow thermal energy to transfer from the cold side of the Stirling engine to the liquid hydrogen tank.

5. The rate at which the heat transfers from the cold side of a Stirling engine to the inner tank is controlled by a helium compressor and storage device, which adjusts the pressure of helium.

6. To allow thermal energy to enter an insulated tank by means of a Stirling engine.
